(19) United States
(12) Patent Application Publication
(10) Pub. No.: US 2010/0051577 A1
(43) Pub. Date: Mar. 4, 2010

(54) COPPER LAYER PROCESSING

(75) Inventor: Neal R. Rueger, Boise, ID (US)

Correspondence Address: BROOKS, CAMERON & HUEBSCH , PLLC, 1221 NICOLLET AVENUE, SUITE 500, MINNEAPOLIS, MN, 55403, US

(73) Assignee: Micron Technology, Inc., Boise, ID (US)

(21) Appl. No.: 12/203,460

(22) Filed: Sep. 3, 2008

(51) Int. Cl. C23F 1/02; H05H 1/00

(52) U.S. Cl. 216/13; 204/164; 204/174; 216/38

(57) ABSTRACT

The present disclosure includes devices, methods, and systems for processing copper and, in particular, copper layer processing using sulfur plasma, One or more embodiments can include a method of forming a copper sulfur compound by reacting copper with a plasma gas including sulfur and removing at least a portion of the copper sulfur compound with water.

### TECHNICAL FIELD

The present disclosure relates to the field of processing copper and, in particular, copper layer processing using sulfur plasma.

### BACKGROUND

Copper (Cu) can be used in a variety of applications, including in semiconductor device applications. In modern semiconductor device applications, numerous components are packed onto a single small area, for instance, on a semiconductor substrate, to create an integrated circuit.

As the size of integrated circuits is reduced, the components and devices that make up the circuits must be positioned closer together in order to comply with the limited space available. As the industry strives towards a greater density of active components per unit area, effective and accurate creation and isolation between circuit components becomes all the more important.

Copper can be a metal to use in a wide variety of semiconductor applications. Copper has a lower electrical resistivity, good electromigration performance, and increased stress migration resistance. These material properties are desired in semiconductor applications and can account for the use of copper in interconnect lines and contacts instead of other metals, such as aluminum (Al). The lower electrical resistance can allow signals to move faster by reducing the RC time delay.

However, the introduction of Cu into multilevel metallization architecture in semiconductor devices can require new processing methods for Cu patterning. Copper can be difficult to dry etch, therefore, new process schemes have been developed for Cu patterning, such as damascene processing. The damascene approach is based on etching features in the dielectric material, filling them with Cu metal, and planarizing the top surface by chemical mechanical polishing (CMP). Dual damascene schemes integrate both the contacts and the interconnect lines into a single processing scheme. However, Cu CMP technology is challenging and it has difficulty defining extremely fine features.

An alternative to the damascene approach is a patterned etching of a Cu layer. The patterned etch process involves deposition of a Cu layer on a substrate; the use of a patterned hard mask or photoresist over the Cu layer; patterned etching of the Cu layer using a reactive ion etching (RIE) process; and deposition of dielectric material over the patterned Cu layer. Patterned etching of Cu can have advantages over damascene processes since it is easier to etch fine Cu patterns and then deposit a dielectric layer onto the Cu pattern, than it is to get barrier layer materials and Cu metal to adequately fill small feature openings in a dielectric film.

An etch gas for etching Al and Cu layers can be a chlorine-containing gas in a gas mixture that includes argon (Ar). The chlorine-containing gas is selected from a large group of chlorine compounds such as Cl₂, HCl, BCl₃, SiCl₄, CHCl₃, CCl₄, and combinations thereof. To achieve anisotropic etching, Cl₂ is mixed with other chlorine-containing gases that are selected from the above list, since the use of Cl₂ alone results in isotropic etching.

Etching of Cu layers using chlorine plasma involves physical sputtering of the CuClₓ layer by energetic ions in the plasma. The etching rates with this method are very low and another drawback is that the sputtered CuClₓ coats the chamber walls and this requires periodic cleaning of the chamber. An equally serious problem is encountered when high-aspect-ratio features are etched in chlorine plasma and the sputtered CuClₓ products redeposit on the feature sidewalls where the effects of physical sputtering are reduced.

Furthermore, when the process is carried out at elevated temperatures (>200.degree. C.) to increase the volatility of the reacted Cu layer, corrosion can occur due to accumulated CuClₓ etch residues on the surface. If these residues are not removed by a post-etch cleaning step, they can cause continuing corrosion of the Cu even after the application of a protective layer over the etched features.

Other approaches for dry etching of Cu that involve copper halides have been examined to try to accomplish higher Cu etch rates. In addition to high processing temperature, the use of additional energy sources, such as exposure of the etch surface to UV or IR light to accelerate the desorption of CuClₓ have been proposed. These alternative approaches are not practical for semiconductor batch processing of large substrates due to poor etch uniformity, high cost and added equipment complexity, and reliability problems.

### BRIEF DESCRIPTION OF THE DRAWINGS

FIG. 1A illustrates a schematic cross-sectional view of a copper layer on a substrate.

FIG. 1B illustrates schematic cross-sectional view of a copper layer on a substrate with a hard mask pattern on the copper layer.

FIG. 1C illustrates schematic cross-sectional view of a copper layer on a substrate with a hard mask pattern on the copper layer and a copper sulfur compound.

FIG. 1D illustrates schematic cross-sectional view of a copper layer on a substrate with a hard mask pattern on the copper layer with the copper sulfur compound removed.

FIG. 1E illustrates schematic cross-sectional view of a copper layer on a substrate with the hard mask pattern and the copper sulfur compound removed.

FIG. 2 illustrates a general diagram of a plasma generation device suitable for use with embodiments of the present disclosure.

FIG. 3 illustrates the surface data for the elements present in a copper structure before processing, post processing, and post processing after a water rinse.

### DETAILED DESCRIPTION OF THE DISCLOSURE

The present disclosure includes devices, methods, and systems for processing copper and, in particular, copper layer processing using sulfur plasma. One or more embodiments can a include a method of forming a copper sulfur compound by reacting copper with a plasma gas including sulfur and removing at least a portion of the copper sulfur compound with water.

In the following detailed description of the present disclosure, reference is made to the accompanying drawings that form a part hereof, and in which is shown by way of illustration how one or more embodiments of the disclosure may be practiced. These one or more embodiments are described in sufficient detail to enable those of ordinary skill in the art to practice the one or more embodiments of this disclosure, and it is to be understood that other embodiments may be utilized and that process, electrical, or mechanical changes my be made without departing from the scope of the present disclosure.

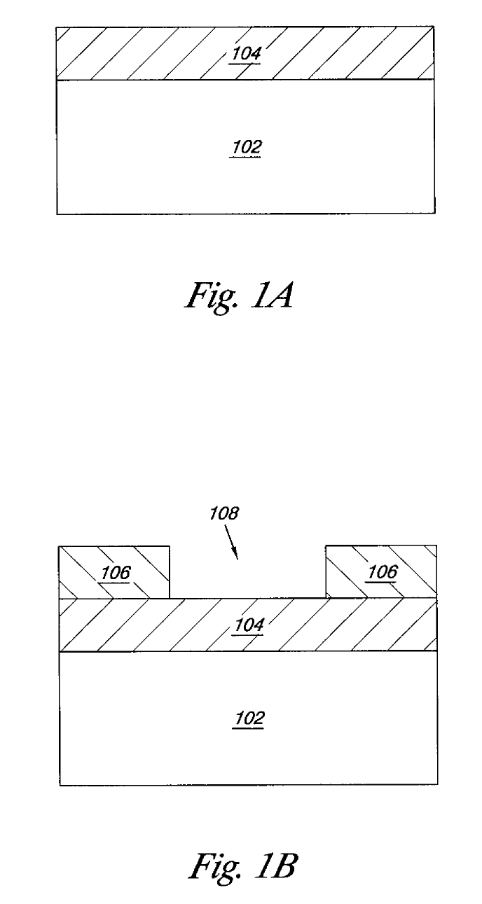

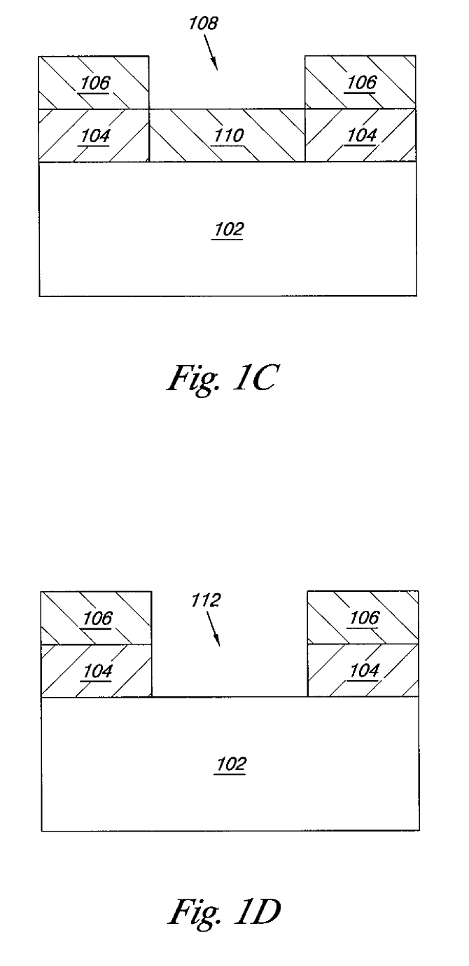

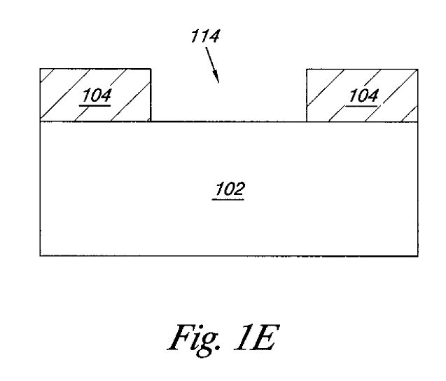

FIG. 1A illustrates a schematic cross-sectional view of a copper layer on a substrate. In FIG. 1A, the substrate 102 can consist of any semiconductor material, such as silicon, a dielectric material, and/or any other substrate material. A copper layer 104 is formed on the substrate 102. The copper layer 104 can be deposited in a number of ways, including sputtering, chemical vapor deposition (CVD), and atomic layer deposition (ALD), among other methods for forming layers of copper.

In various embodiments, the copper layer 104 can include a constant layer over the surface of the substrate 102. In other embodiments the copper layer 104 can be patterned to cover a desired area of the substrate 102, leaving a portion of the substrate 102 exposed. The copper layer 104 can be any desired thickness. In the embodiment of FIG. 1, the copper layer 104 is approximately 100 angstroms (Å).

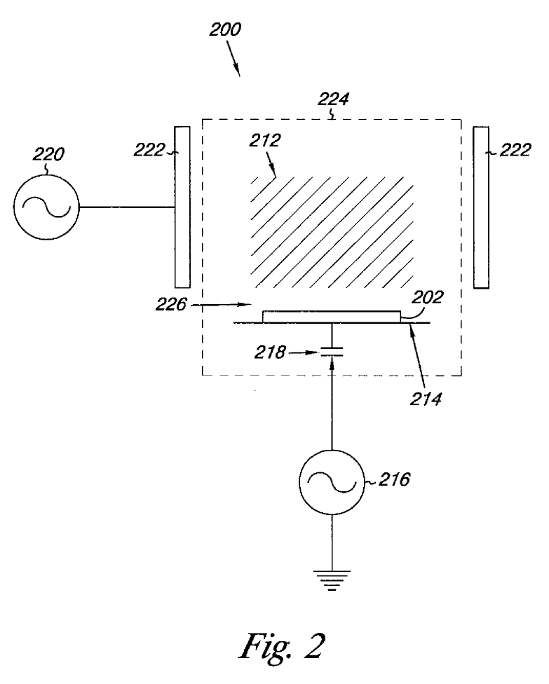

FIG. 1B illustrates a schematic cross-sectional view of a copper layer on a substrate with a hard mask pattern on the copper layer. In FIG. 2, a photo resist layer 106 or hard mask layer 106 is patterned over the copper layer 104. The photo resist layer 106 or hard mask layer 106 is used to mask a portion of the copper layer 104 from exposure to a developer or a plasma.

In various embodiments, plasma gas 108 is introduced to the copper 104 in a plasma chamber. In some embodiments, gases used to form the plasma gas 108 can include sulfur dioxide and an inert gas. A number of inert gases, such as Ar, Ne, He, Xe, or Kr, or other relatively inert gas compounds, such as O₂, N₂, or H₂, can be used. In various embodiments, once the gases are exposed to a voltage potential, the plasma gas 108 created can include sulfur oxide and sulfur, which reacts with the exposed portion of the copper layer 104.

FIG. 1C illustrates schematic cross-sectional view of a copper layer on a substrate with a hard mask pattern on the copper layer and a copper sulfur compound. In FIG. 1C, when the copper layer is exposed to the plasma gas 108, a copper sulfur compound 110 is formed. In one or more embodiments, the plasma gas 108 can be introduced to the copper layer for 120 seconds with a radio frequency (RF) source power of 1000 Watts (W) and an RF bias power of 250 W. These control settings in the plasma chamber can result in a plasma process reaction to a depth of 200 Angstroms (Å), for example, while other control settings can be used to alter the processing properties and results depending on the desired process characteristics. In various embodiments, a number of copper sulfur compounds can be formed, such as copper sulfate (CuSO4), chalcanthite (CuSO4.5H2O or bluestone), copper sulfide (CuS), or copper sulfite (CuSO), among other copper sulfur compounds.

FIG. 1D illustrates schematic cross-sectional view of a copper layer on a substrate with a hard mask pattern on the copper layer with the copper sulfur compound removed. In FIG. 1D, the copper sulfur compound is removed with a water rinse 112. Copper sulfur compounds are soluble in water, therefore allowing a de-ionized stream of water dissolve the copper sulfur compound and rinse away the mixture. The removal of the copper sulfur compound results in the exposure of the substrate 102. The substrate 102 can be silicon dioxide (SiO2).

FIG. 1E illustrates schematic cross-sectional view of a copper layer on a substrate with the hard mask pattern and the copper sulfur compound removed. In FIG. 1E, the photoresist or hard mask is removed from the structure leaving a gap 114 between the patterned copper layer 104 and leaving the substrate 102 exposed.

The process steps described in association with FIGS. 1A-1E can be used to process copper in a number of applications. In one or more embodiments, the patterned copper layer can be part of a semiconductor device. The patterned copper layer can form interconnect lines to electrically couple various components of a semiconductor device, include memory cells. The interconnect lines can for data lines and/or access lines in a semiconductor device.

Also, the plasma processing of the present disclosure can be used to planarize a copper layer. The planarization of a copper layer can occur by plasma processing the copper layer with sulfur for a certain time period at a certain intensity to obtain a chemical reaction to a desired depth in the copper layer. The deionized water rinse can be used to remove the reacted copper in the copper sulfur compounds, leaving a planarized copper surface at a desired level.

In various embodiments, once the copper sulfur compound is removed with a water rinse, the copper sulfur water solution can be further processed to obtain reclaimed copper. The reclaimed copper can then be used in further processing applications.

FIG. 2 illustrates a general diagram of a plasma generation device suitable for use with embodiments of the present disclosure. FIG. 2 generally shows an illustrative reactor 200 for performing plasma processing. It should be recognized that this is an illustrative diagram representative of an entire system even though only several components of the system are shown. Various systems incorporating many elements in various configurations may be utilized. To generate plasma 212, the different gas mixtures according to the present disclosure are provided to the illustrative plasma generator 200.

The illustrative reactor 200 includes a powered electrode 214 connected to an RF bias source 216 via capacitance 218 upon which a semiconductor substrate having a layers to be processed is placed. Further, an RF source 220 is connected to elements 222, e.g., coils, for generating the plasma 212 in chamber 224. Ion sheath 226 is formed between the plasma 212 and the powered electrode 214. With the semiconductor substrate 202 positioned within the illustrative plasma generation apparatus 200, one or more layers on the semiconductor substrate are processed using a gas chemistry of SO₂. The power source 220 utilized may be any suitable power source including an RF generator, a microwave generator, etc.

In the various embodiments of this disclosure, a number of plasma processing systems can be used. In performing a plasma process, a wafer can be loaded in the reactor chamber and centered on a disk-shaped lower electrode, thereby becoming electrically integrated therewith. A disk-shaped upper electrode can be positioned above the wafer. The flow of molecular gas into the chamber can be regulated by mass-flow controllers. A radio-frequency voltage can be applied between the electrodes. Chamber pressure can be monitored and maintained continuously through a feedback loop between a chamber manometer and a downstream throttle valve, which allows reactions products and surplus gas to escape in controlled manner.

The spacing of the electrodes can be controlled by a closed-loop positioning system. At a particular voltage known as the breakdown voltage, a glow discharge may be established between the electrodes, resulting in a partial ionization of the molecular gas. In such a discharge, free electrons gain energy from the imposed electric field and lose this energy during collisions with molecules. Such collisions lead to the formation of new species, including metastables, atoms, electrons, free radicals, and ions.

The electrical discharge between the electrodes may consist of a glowing plasma region centered between the lower electrode and the upper electrode in a lower dark space between the lower electrode and the plasma region, and an upper dark space region between the upper electrode and plasma region.

The dark space regions can be referred to as sheath regions. Electrons emitted from the electrodes are accelerated into the discharge region. As the electrons reach the plasma region, their kinetic energy ionizes a portion of the molecular gas molecules and raises the electrons of other molecular gas molecules to less-stable atomic orbitals of increased energy through a mechanism known as electron impact excitation.

As each of the excited electrons returns to a more stable orbital, a quantum of energy is released in the form of light. This light gives the plasma region its characteristic glow. Free electrons may also collide with species already formed by collisions between free electrons and gas molecules, leading to additional subspecies. The free electrons are accelerated much more rapidly toward the electrodes than are ionized gas molecules due to their small mass, leaving the plasma with a net positive charge.

As an ion collides with an atom or molecule of reactive material on the wafer, the two may react to form a reaction product. Ion bombardment of the electrodes with ions and electrons causes an elevation of electrode temperature, as a result both electrodes are normally cooled by the circulation of deionized water through the electrodes and an external temperature control unit. Water cooling prevents elevation of wafer temperature to levels which would destabilize photoresist. Some plasma reactors consist of a single process chamber flanked by two loadlock chambers, one chamber for wafer isolation during loading and the other chamber for isolation during unloading.

In various embodiments, an etching technique can be used for processing a copper layer and for fabricating a device. The technique can include transferring a resist pattern produced by lithography onto an object to be processed, i.e., to a copper layer, a semiconductor thin film, a magnetic thin film, etc., and includes methods such as reactive ion etching. Reactive ion etching method is a kind of dry etching method, and is advantageous in that it enables a precise transfer of patterns produced by lithography, and that it is suitable for fine processing and provides a desirable etching rate.

The reactive-ion etching method comprises placing the work piece in a plasma of a reactive gas while applying an electric field, and physically and chemically removing layers of atoms by the incident ion beams that are irradiated vertically to the surface of the work piece. This method enables anisotropic processing cutting vertically along the boundary of the mask, and hence, it allows transfer of fine and sharp patterns.

In case of reactive-ion etching, the chemically active species such as the ions or radicals of the reactive gases that are generated in the plasma are adsorbed onto the surface of the work piece and undergo chemical reaction to form a layer of chemical products having a low bonding energy. Since the surface of the work piece are exposed to the impact of the positive ions that are accelerated in the plasma by an electric field and which are vertically incident to the surface, the surface layers that are loosely bonded are successively stripped off by a deionized water rinse, the sputtering of ions, or by the evaporation into vacuum. In one or more embodiments, the reactive-ion etching process can be regarded as a process in which a chemical reaction and a physical process proceed simultaneously, and it is characterized by having a selectivity on a specific substance and having anisotropy as such to cut vertically into the surface of the object.

In one or more embodiments, a variety of plasma processing methods and techniques may be used to provide the plasma processing of the copper layer described in this disclosure. The embodiments of this disclosure are not limited to the plasma processing method described above and can include a number of other plasma processing methods.

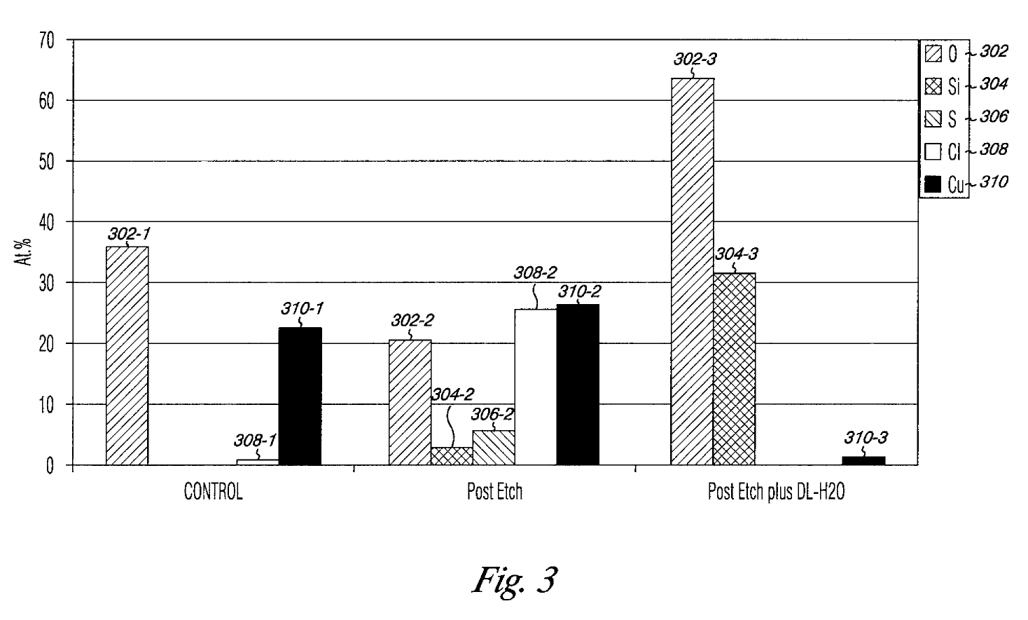

FIG. 3 illustrates the surface data for the elements present in a copper structure before processing, post processing, and post processing after a water rinse. The structure from FIG. 1E that remains after under going the process steps described in association with FIGS. 1A-1E can result in a structure that has patterned copper and an exposed substrate. The surface data illustrated in FIG. 3 shows that the process steps described in the discussion of FIGS. 1A-1E is effective in removing the portion of the copper layer that is exposed during the plasma process.

The graph of FIG. 3 illustrates the atomic percentage of various elements on the surface of three samples. The first sample is a control sample of a process wafer, the second sample is a process wafer after the copper layer has undergone sulfur oxide plasma processing, and the third sample is the process wafer after a deionized water rinse of the process wafer. The elements present in the three samples include oxygen (O) 302, silicon (Si) 304, sulfur (S) 306, chlorine (Cl) 308, and copper (Cu) 310.

In the control sample, the process wafer has a large percentage of oxygen (O) and copper (Cu) on the surface and small percentage of chlorine (Cl). The oxygen 302-1 atomic percentage is approximately 36%, and the copper 310-1 atomic percentage is approximately 22%. The presence of oxygen on the control sample may result from environmental oxidation of the copper layer that is on the process wafer. The chlorine 308-1 atomic percentage is approximately 1% and can be a result of residual chlorine being in the plasma chamber, as chlorine is a common plasma processing gas.

In the post processing sample, the composition of the surface has changed. Sulfur and silicon are now present on the surface of the process wafer, along with varying atomic percentages of oxygen, copper, and chlorine. Copper 310-2 has an atomic percentage of approximately 36% and sulfur 306-2 has an atomic percentage of approximately 5%. These atomic percentages indicate the formation of copper sulfur compounds during the plasma process. Also, the high atomic percentage of oxygen 302-2 (approximately 20%) present indicates that copper sulfur oxygen compounds may be formed during the plasma process. The atomic percentage of silicon 304-2 is a result of the copper surface film on the process wafer has expanded during the plasma process and is thicker in a reacted form, leaving some exposed silicon on the surface. Also, the high atomic percentage of chlorine 308-2 can be a result of residual chlorine in the plasma chamber and the high affinity of chlorine to react with copper.

In the post process deionized water rinse sample, the composition of the surface is again changed as nearly all of the copper is removed during the rinse process step. Only a trace residue of copper remains after the water rinse has occurred on the process wafer. The amount of remaining copper 310-3 is only approximately 1 atomic percentage. The surface is primarily comprised of oxygen 302-3 and silicon 304-3. These large of atomic percentages of approximately 63% and 31%, respectively, indicate that the copper sulfur and or copper sulfur oxygen compounds that were formed during the plasma process are removed during the rinse process. The presence of oxygen and silicon show that the silicon dioxide substrate on the process wafer is now exposed and the copper layer has been removed during the process steps. Also, the presence of oxygen and silicon indicates that the substrate is not attacked during the process steps, resulting in very little chance for undercut when using this process to process and pattern a copper layer.

### CONCLUSION

Devices, methods, and systems for processing copper and, in particular, copper layer processing using sulfur plasma, have been described herein. One or more embodiments can a include a method of forming a copper sulfur compound by reacting copper with a plasma gas including sulfur and removing at least a portion of the copper sulfur compound with water.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of processing copper, comprising:
forming a copper sulfur compound by reacting copper with a plasma gas including sulfur; and
removing at least a portion of the copper sulfur compound with water.

2. The method of claim 1, wherein the copper sulfur compound is copper sulfate (CuSO₄).

3. The method of claim 1, wherein the copper sulfur compound is a copper sulfide (CuₓSₓ).

4. The method of claim 1, wherein the plasma gas includes a sulfur compound and an inert gas.

5. The method of claim 1, wherein the plasma gas includes a carbon oxygen sulfur compound.

6. The method of claim 1, wherein the plasma gas is powered in a chamber with 1000 Watts (W).

7. The method of claim 6, wherein the plasma gas is powered in the chamber with a radio frequency (RF) bias power of 250 W for 120 seconds.

8. A computer readable medium having instructions stored thereon and executable by a processor to cause a device to perform a method, comprising:
depositing a copper layer on a substrate;
depositing a silicon dioxide layer on the copper layer;
patterning the layer of silicon dioxide to expose a portion of the copper layer; and
reacting the exposed portion of the copper layer with a plasma sulfur gas mixture to form a copper sulfur compound.

9. The computer readable medium of claim 8, wherein the copper sulfur compound is soluble in water.

10. The computer readable medium of claim 8, wherein the copper sulfur compound is chalcanthite.

11. The computer readable medium of claim 8, wherein the method includes removing the copper sulfur compound with deionized water.

12. The computer readable medium of claim 8, wherein the sulfur gas mixture includes a carbon oxygen sulfur compound.

13. The computer readable medium of claim 12, wherein the copper oxygen sulfur compound includes chlorine.

14. A method of planarizing copper, comprising:
depositing a copper layer on a substrate;
reacting a portion of the copper layer with a plasma sulfur gas mixture to a desired depth to form a copper sulfur compound to the desired depth; and
removing the copper sulfur compound with water to planarize the surface of the layer of copper.

15. The method of claim 14, wherein the copper sulfur compound is copper sulfate (CuSO₄).

16. The method of claim 14, wherein the copper sulfur compound is a copper sulfide (CuₓSₓ).

17. The method of claim 14, wherein the method includes reacting the portion of the copper layer with the sulfur gas mixture that includes a sulfur compound and an inert gas.

18. The method of claim 14, wherein the method includes removing the copper sulfur compound to a depth of 200 angstroms (Å).

19. The method of claim 14, wherein the sulfur gas mixture includes a carbon oxygen sulfur compound.

20. The method of claim 14, wherein the method includes reclaiming copper from a solution of the sulfur compound and water.

21. A method of operating a reaction chamber, comprising:
depositing a copper layer on a substrate in the chamber;
reacting the copper layer with a plasma sulfur gas mixture to form a copper sulfur compound; and
forming a patterned copper layer by removing the copper sulfur compound with water.

22. The method of claim 21, wherein the method includes covering the copper layer with a hard mask.

23. The method of claim 21, wherein the copper sulfur compound is copper sulfide.

24. The method of claim 21, wherein the sulfur gas mixture includes a sulfur compound and an inert gas.

25. The method of claim 21, wherein the sulfur gas mixture includes a carbon oxygen sulfur compound.

26. The method of claim 21, wherein the patterned copper layer forms a portion of a memory device.

27. The method of claim 26, wherein the patterned copper layer forms an interconnect line in the memory device.

28. The method of claim 27, wherein the interconnect line is a data line in the memory device.

29. The method of claim 27, wherein the interconnect line is an access line in the memory device.
